(19) United States
(12) Patent Application Publication
(10) Pub. No.: US 2012/0046806 A1
(43) Pub. Date: Feb. 23, 2012

(54) SPECIFICATION INFORMATION ESTIMATING DEVICE AND VEHICLE

(75) Inventors: Takahiro Yokota, Susono-shi (JP); Yutaka Obuchi, Susono-shi (JP); Yuuichi Toyoda, Gotemba-shi (JP); Hiroaki Endo, Suntou-gun (JP)

(73) Assignee: TOYOTA JIDOSHA KABUSHIKI KAISHA, Toyota-shi, Aichi (JP)

(21) Appl. No.: 13/264,860

(22) PCT Filed: May 13, 2009
(86) PCT No.: PCT/JP2009/058924

§ 371 Date: Oct. 17, 2011

(51) Int. Cl. G06F 7/00; B62D 15/02

(52) U.S. Cl. 701/1

(57) ABSTRACT

Disclosed is a specification information estimating device which estimates the steering gear ratio n of a vehicle. A specification information estimating device includes a steering angle sensor 26 and a yaw rate sensor 51 which acquire the wheel steering angle St and the yaw rate Yr of the vehicle during traveling, and an ECU 4 which estimates a steering gear ratio n on the basis of the wheel steering angle St and the yaw rate Yr acquired by the steering angle sensor 26 and the yaw rate sensor 51. Therefore, it is possible to estimate the steering gear ratio n of each vehicle without using a stability factor K_{H}.

### TECHNICAL FIELD

The present invention relates to a device for estimating specification information of a vehicle, and a vehicle.

### BACKGROUND ART

A method has been heretofore known in which the motion of a vehicle is controlled using a stability factor as a function value specific to the vehicle (for example, see Patent Literature 1). According to the method described in Patent Literature 1, the stability factor which controls the motion of the vehicle is set on the basis of the traveling result during factory shipment or the like, or the characteristics of a model vehicle, such as a prototype vehicle. That is, according to this method, the stability factor is calculated using specification information, such as the gear ratio (steering gear ratio) of a steering box of the model vehicle, the wheelbase length, or the like.

### CITATION LIST

### Patent Literature

[Patent Literature 1] Japanese Unexamined Patent Application Publication No. 2006-131052

### SUMMARY OF INVENTION

### Technical Problem

However, even in vehicles of the same type as the model vehicle, specification information, such as the steering gear ratio or the wheelbase length, may differ between the vehicles. In this case, according to the method described in Patent Literature 1, it is difficult to accurately calculate the stability factor, and as a result, it may be impossible to control the motion of the vehicle with satisfactory precision.

In estimating the steering gear ratio or the wheelbase length, it is possible to calculate the steering gear ratio or the wheelbase length using an equation of motion of a vehicle model. Meanwhile, since a stability factor is included in the equation of motion of the vehicle model, if the stability factor is not known, it may be impossible to estimate the steering gear ratio and the wheelbase length.

Accordingly, the invention has been finalized in order to solve the problems in the related art, and an object of the invention is to provide a specification information estimating device and a vehicle capable of estimating specification information without using a stability factor.

### Solution to Problem

An aspect of the invention provides a specification information estimating device which estimates the steering gear ratio of a vehicle. The device includes a traveling data acquisition unit which acquires the steering angle and the yaw rate of the vehicle during traveling, and a steering gear ratio estimation unit which estimates the steering gear ratio on the basis of the steering angle and the yaw rate acquired by the traveling data acquisition unit.

In the specification information estimating device according to the aspect of the invention, the traveling data acquisition unit acquires the steering angle and the yaw rate during traveling, and the steering gear ratio estimation unit estimates the steering gear ratio using the steering angle and the yaw rate. For this reason, even when the steering gear ratio differs between vehicles, it is possible to estimate the steering gear ratio of each vehicle without using a stability factor, making it possible to control the motion of the vehicle with satisfactory precision.

It is preferable that the steering gear ratio estimation unit changes processing for estimating the steering gear ratio on the basis of a magnitude relationship between the steering angle and a predetermined threshold value. The steering angle dependency of an actual tire turning angle changes on the basis of the magnitude of the steering angle. For this reason, the estimation processing changes on the basis of the magnitude of the steering angle to change the estimation processing between, for example, a small steering angle and a large steering angle, thereby estimating the steering gear ratio. Therefore, it is possible to estimate the steering gear ratio with satisfactory precision.

It is preferable that the traveling data acquisition unit further acquires the lateral acceleration of the vehicle during traveling, and the steering gear ratio estimation unit estimates the steering gear ratio using the steering angle and the yaw rate acquired by the traveling data acquisition unit during traveling under the traveling condition that the lateral acceleration is within a predetermined range.

It is preferable that the traveling data acquisition unit further acquires the vehicle speed of the vehicle during traveling, the traveling condition includes the condition that an operational value obtained by subtracting a value obtained by accumulating the yaw rate and the vehicle speed when the vehicle speed is within a predetermined range from the lateral acceleration is within a predetermined range, and the steering gear ratio estimation unit estimates the steering gear ratio using the steering angle and the yaw rate acquired by the traveling data acquisition unit during traveling in which the traveling condition is satisfied. With this configuration, it becomes possible to estimate the steering gear ratio using, for example, the equation of motion of the vehicle model while excluding the influence of the stability factor.

Another aspect of the invention provides a vehicle which performs vehicle control on the basis of a steering gear ratio. The vehicle includes a vehicle control unit which estimates the steering gear ratio on the basis of a steering angle and a yaw rate, and changes vehicle control presuming a change in the steering gear ratio.

In the vehicle according to another aspect of the invention, the vehicle control unit estimates the steering gear ratio on the basis of the steering angle and the yaw rate, and changes vehicle control presuming a change in the steering gear ratio. For this reason, even when the steering gear ratio differs between vehicles, it is possible to perform vehicle control with satisfactory precision without using a stability factor.

A further aspect of the invention provides a specification information estimating device which estimates the wheelbase of a vehicle. The device includes a traveling data acquisition unit which acquires the steering angle and the yaw rate of the vehicle during traveling, and a wheel base estimation unit which estimates the wheelbase on the basis of the steering angle and the yaw rate acquired by the traveling data acquisition unit.

In the specification information estimating device according to a further aspect of the invention, the traveling data acquisition unit acquires the steering angle and the yaw rate during traveling, and the wheelbase estimation unit estimates the wheelbase using the steering angle and the yaw rate. For this reason, even when the wheelbase differs between vehicles, it is possible to estimate the wheelbase of each vehicle without using a stability factor, making it possible to control the motion of the vehicle with satisfactory precision.

A still further aspect of the invention provides a vehicle which performs vehicle control on the basis of a wheelbase. The vehicle includes a vehicle control unit which estimates the wheelbase on the basis of a steering angle and a yaw rate, and changes vehicle control presuming a change in the wheelbase.

In the vehicle according a still further aspect of the invention, the vehicle control unit estimates the wheelbase on the basis of the steering angle and the yaw rate, and changes vehicle control presuming a change in the wheelbase. For this reason, even when the wheelbase differs between vehicles, it is possible to perform vehicle control with satisfactory precision without using a stability factor.

### Advantageous Effects of Invention

According to the invention, it is possible to estimate specification information without using a stability factor.

### BRIEF DESCRIPTION OF DRAWINGS

FIG. 1 is a schematic configuration diagram of a vehicle having a specification information estimating device according to an embodiment.

FIG. 2 is a block diagram of a vehicle having a specification information estimating device according to an embodiment.

FIG. 3 is a flowchart showing the operation of a specification information estimating device according to an embodiment.

FIG. 4 is a schematic view illustrating the operation of a specification information estimating device according to an embodiment.

### DESCRIPTION OF EMBODIMENTS

Hereinafter, an embodiment of the invention will be described with reference to the accompanying drawings. In the drawings, the same or equivalent parts are represented by the same reference numerals, and overlapping description will be omitted.

A specification information estimating device according to this embodiment is a device which estimates specification information of a vehicle, and is suitably used during factory shipment of a vehicle or during vehicle adjustment, such as repair and inspection. The specification information of the vehicle includes, for example, a steering gear ratio, a wheelbase length, and the like. In this embodiment, as an example of a specification information estimating device, a steering gear ratio estimating device will be described. The steering gear ratio estimating device is a device which estimates the steering gear ratio of a vehicle.

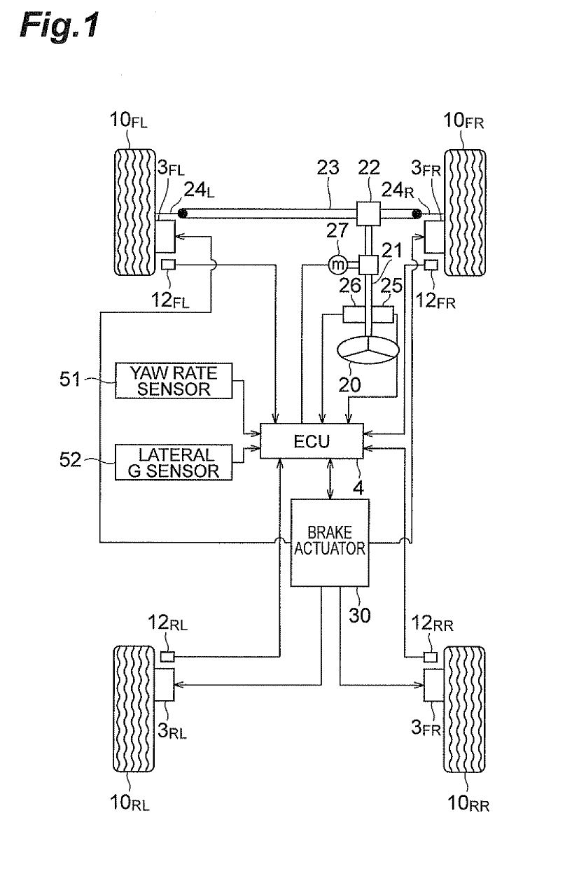

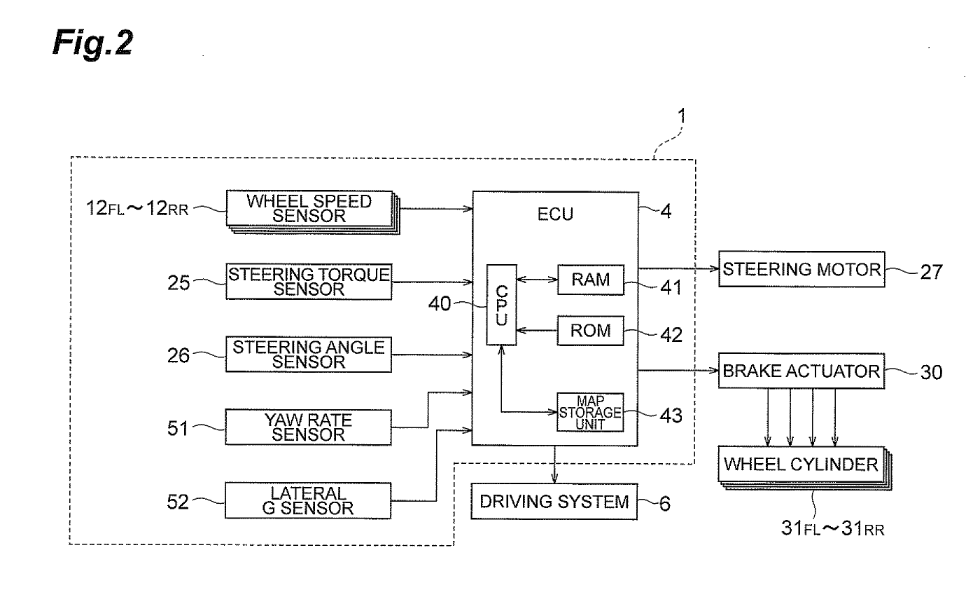

First, the configuration of a vehicle having the steering gear ratio estimating device of this embodiment will be described. FIG. 1 is a schematic configuration diagram showing the configuration of a vehicle having the steering gear ratio estimating device of this embodiment. FIG. 2 is a block diagram of a control section of a vehicle having the steering gear ratio estimating device of this embodiment.

As shown in FIG. 1, the front wheels 10FL and 10FR of the vehicle are turning wheels, and are connected to a steering system. The steering system includes a steering wheel 20 which is arranged in the vehicle interior rotatably around the rotational shaft thereof and receives a steering input by a driver, a steering shaft 21 which is connected to the steering wheel 20 to transmit the rotational force of the steering wheel 20, a steering gear box 22 which is a rack-and-pinion gear mechanism for converting the rotation of the steering shaft 21 to linear motion, and a relay rod 23 and tie rods 24L and 24R which transmit the converted linear motion to the front wheels 10FL and 10FR.

In the steering shaft 21 are arranged a steering angle sensor 26 which detects a wheel steering angle St by the driver, a steering torque sensor 25 which detects steering torque T, and a steering motor 27 which provides steering torque by motion.

The vehicle has a configuration such that a braking force which is added by brake devices 3FL to 3RR respectively arranged in four wheels 10FL to 10RR can be independently adjusted. In the wheels 10FL to 10RR, in addition to the brake devices 3FL to 3RR, wheel speed sensors 12FL to 12RR for detecting the wheel speed are respectively arranged.

The brake devices 3FL to 3RR respectively arranged in the four wheels 10FL to 10RR are, for example, hydraulic brake devices, and wheel cylinders 31 FL to 31 RR are respectively arranged in the brake devices 3FL to 3RR. The brake devices 3FL to 3RR are connected to a brake actuator 30, and control the hydraulic pressure thereto to control driving force distribution.

The ECU (Electric Control Unit) 4 serving as a control device includes a CPU, a ROM, a RAM, an input/output interface, and the like. The ECU 4 receives the outputs of a yaw rate sensor 51 and a lateral G sensor 52, in addition to the wheel speed sensors 12FL to 12RR, the steering torque sensor 25, and the steering angle sensor 26, as input, and controls a driving system 6 including an engine, in addition to the steering motor 27 and the brake actuator 30. The driving system 6 may be controlled directly by the ECU 4 or may be controlled by sending a control command to a control device exclusively for the driving system 6.

The ECU 4 has a function of controlling the behavior of the vehicle using a control parameter. The control parameter includes a stability factor or the like which is a function value specific to the vehicle depending on, for example, the steering gear ratio, the wheelbase, and the vehicle speed. As an example of vehicle control which is performed by the ECU 4, VSC (Vehicle Stability Control) will be described. For example, in order to increase the traveling stability of the vehicle, the ECU 4 has a function of performing control such that the yaw rate of the vehicle coincides with a target yaw rate obtained in advance. The ECU 4 has a function of calculating the target yaw rate on the basis of, for example, a steering angle St, a vehicle speed V, a lateral acceleration G_{y}, and a steering gear ratio, a wheelbase, and a stability factor set in advance, and performing control such that the target yaw rate does not reach an upper limit value.

The control parameter which is used by the ECU 4 may differ between vehicles due to the intersection, misalignment, or the like of individual parts constituting the vehicle. Accordingly, the ECU 4 has a function of estimating a control parameter which differs between vehicles due to the intersection, misalignment, or the like of individual parts constituting the vehicle. For example, the ECU 4 has a function of estimating a steering gear ratio or a wheelbase using measured data acquired during factory shipment or inspection. For example, the ECU 4 has a function of estimating the steering gear ratio or the wheelbase using an equation of motion of a vehicle model when traveling under a traveling condition such that the influence of the stability factor decreases. The details of this function will be described. A target yaw rate when a vehicle is traveling in a grip state is expressed by Expression 1.

$$\begin{matrix}[ Equation 1 ] & \\ YrStd = \frac{V \cdot St}{n \cdot L} - {K}_{H} \cdot {G}_{y} \cdot V & ( 1 )\end{matrix}$$

In Expression 1, YrStd represents a target yaw rate, V represents a vehicle speed, St represents a wheel steering angle (steering angle), n represents a steering gear ratio, L is a wheelbase, K_{H} is a stability factor, and G_{y} is a lateral acceleration.

When the traveling condition is a low speed and a low lateral acceleration, the influence of the second term in Expression 1 decreases. That is, under the relevant traveling condition, an expression is obtained in which the influence of the stability factor is excluded. In this case, the target yaw rate YrStd is expressed by Expression 2.

$$\begin{matrix}[ Equation 2 ] & \\ YrStd = \frac{V \cdot St}{n \cdot L} & ( 2 )\end{matrix}$$

When the vehicle is in a grip state, the target yaw rate YrStd coincides with an actual yaw rate Yr. For this reason, the ECU 4 substitutes the actual yaw rate Yr, the vehicle speed V, and the wheel steering angle St into Expression 2 to calculate a relational expression of a steering gear ratio n and a wheelbase L. If the steering gear ratio n is known, the ECU 4 can estimate the wheelbase L using the calculated relational expression, or if the wheelbase L is known, the ECU 4 can estimate the steering gear ratio n. Expression 2 may be modified using a relational expression with respect to another control value, and the modified Expression 2 may be used or an expression multiplied by an integer or the like may be used.

The steering gear ratio estimating device 1 includes the wheel speed sensors 12FL to 12RR, the steering torque sensor 25, the steering angle sensor 26, the yaw rate sensor 51, the lateral G sensor 52, and the ECU 4. That is, the wheel speed sensors 12FL to 12RR, the steering torque sensor 25, the steering angle sensor 26, the yaw rate sensor 51, and the lateral G sensor 52 function as a traveling data acquisition unit, and the ECU 4 functions as a vehicle control unit and a steering gear ratio estimation unit.

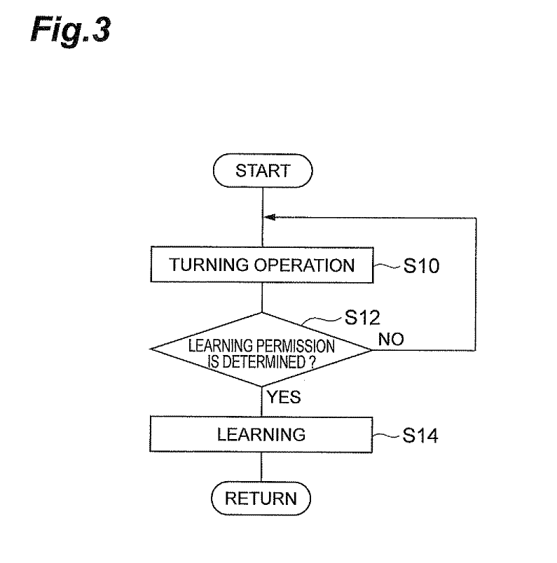

Next, the operation of the steering gear ratio estimating device 1 of this embodiment will be described. Hereinafter, processing for estimating the steering gear ratio n will be described with reference to FIG. 3. FIG. 3 is a flowchart illustrating the operation of the steering gear ratio estimating device of this embodiment. Control processing shown in FIG. 3 is performed by the ECU 4, for example, in a learning process or an inspection process at a factory before shipment. It is assumed that the wheelbase L is known as vehicle specification information.

As shown in FIG. 3, the ECU 4 starts a turning operation (S10). For example, the ECU 4 turns the vehicle along a circle having a radius R at a given vehicle speed V (normal turning). The ECU 4 receives the wheel steering angle St which is the output of the steering angle sensor 26 during traveling, the actual yaw rate Yr which is the output of the yaw rate sensor 51, and the lateral acceleration G_{y} which is the output of the lateral G sensor 52 as input. If the processing of S10 ends, the processing progresses to learning permission determination (S12).

The processing of S12 is performed by the ECU 4, and is processing for determining whether or not learning can be done with traveling data of S10. For example, if a predetermined traveling condition is satisfied for a predetermined period (for example, 3 seconds), the ECU 4 permits learning. The predetermined traveling condition is, for example, that the absolute value of the wheel steering angle St is greater than a predetermined threshold value (for example, 90 deg). This is because, if the absolute value of the wheel steering angle St is not greater than a predetermined threshold value, it may be impossible to obtain traveling data in a sufficient measurement range. The predetermined condition includes that the vehicle speed V is higher than a first threshold value (for example, 7 km/h) and lower than a second threshold value (for example, 13 km/h). This is because the upper limit value of the vehicle speed V should meet low-speed traveling as the premise of Expression 2. The predetermined condition also includes that the absolute value of the lateral acceleration G_{y} is smaller than a predetermined threshold value (for example, 6 m/s²). This is because the upper limit value of the lateral acceleration G_{y} should meet low-acceleration traveling as the premise of Expression 2. The predetermined condition also includes that the vehicle does not undergo driving slip. This is because it is necessary to meet grip traveling as the premise of Expressions 1 and 2. The predetermined condition also includes that the absolute value of a value obtained by subtracting a value Yr·V obtained by accumulating the yaw rate Yr and the vehicle speed V from the lateral acceleration G_{y} is smaller than a predetermined threshold value (for example, 0.2 m/s²). This is because it is necessary to meet grip traveling as the premise of Expressions 1 and 2. When the ECU 4 determines that one of the above-described traveling conditions is not satisfied, the process progresses to the turning operation again, and the processing of S10 and S12 is repeatedly performed until the above-described traveling conditions are satisfied for a predetermined period. When the ECU 4 determines that all the above-described traveling conditions are satisfied, the process progresses to learning (S14).

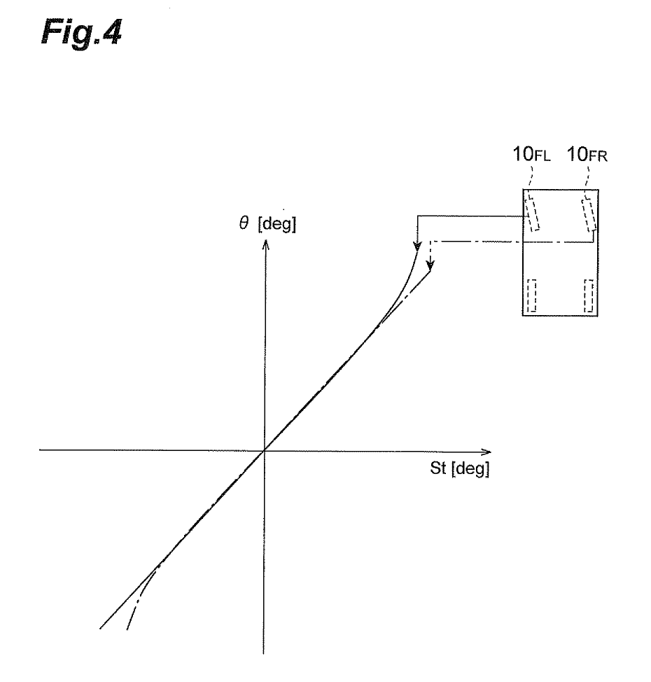

The processing of S14 is performed by the ECU 4, and is processing for calculating and learning the steering gear ratio n. The ECU 4 calculates the steering gear ratio n using traveling data input in S10 for a learning permission time determined in S12. Here, the ECU 4 changes an estimation operation depending on whether the wheel steering angle St becomes a small steering angle region (for example, a range of 90 to 180 deg) or a large steering angle region (for example, a range equal to or greater than 180 deg). The reason is as follows. For example, as shown in FIG. 4, when the wheel steering angle St becomes the small steering angle region, a value obtained by dividing the wheel steering angle St by the steering gear ratio n substantially becomes equal to the actual tire turning angle θ. Meanwhile, when the wheel steering angle St becomes the large steering angle region, the relationship is not satisfied. The ECU 4 calculates the steering gear ratio n using Expression 3, for example, when the wheel steering angle St becomes the small steering angle region.

$$\begin{matrix}[ Equation 3 ] & \\ n = \frac{V \cdot St}{L \cdot Yr} & ( 3 )\end{matrix}$$

The ECU 4 sets a value obtained by temporally averaging the steering gear ratio n calculated using Expression 3 as a learning value. Alternatively, when the set steering gear ratio n is known, the ECU 4 may use a value closest to the set steering gear ratio n from among the calculates steering gear ratios n.

When the wheel steering angle St becomes the large steering angle region, for example, the ECU 4 sets a correction term for correcting the tire turning angle θ calculated from FIG. 4 as F(St). The wheel steering angle dependency of the tire turning angle θ shown in FIG. 4 can be obtained from stationary steering data. The ECU 4 calculates the steering gear ratio n using Expression 4.

$$\begin{matrix}[ Equation 4 ] & \\ n = \frac{V \cdot St}{( L + \frac{V}{Yr } F ( St ) ) \cdot Yr} & ( 4 )\end{matrix}$$

Similarly to when the wheel steering angle St becomes the small steering angle region, the ECU 4 sets a value obtained by temporally averaging the steering gear ratio n calculated using Expression 4 as a learning value. Alternatively, when the set steering gear ratio n is known, the ECU 4 may use a value closest to the set steering gear ratio n from among the calculated steering gear ratios n as a learning value. If the processing of S14 ends, the control processing shown in FIG. 3 ends.

With the above, the control processing shown in FIG. 3 ends. The control processing shown in FIG. 3 is performed, such that the steering gear ratio n is estimated without using a stability factor K_{H}. In a vehicle in which a system for performing vehicle control using the steering gear ratio n is mounted, if a plurality of steering gear ratios n are set, it is necessary to change an ECU between vehicles. For this reason, cost may increase. However, if the control processing shown in FIG. 3 is performed, the steering gear ratio n can be learned, making it possible to suppress an increase in cost due to ECU change or imposition.

The ECU 4 performs vehicle control using the steering gear ratio n obtained by performing the control processing shown in FIG. 3, thereby performing vehicle control with satisfactory precision.

As described above, according to the steering gear ratio estimating device 1 of this embodiment, the steering angle sensor 26 and the yaw rate sensor 51 acquire the wheel steering angle St and the yaw rate Yr during traveling, and the ECU 4 estimates the steering gear ratio n using the wheel steering angle St and the yaw rate Yr. For this reason, even when the steering gear ratio n differs between vehicles, it is possible to estimate the steering gear ratio n of each vehicle without using the stability factor K_{H}, making it possible to control the motion of the vehicle with satisfactory precision.

According to the steering gear ratio estimating device 1 of this embodiment, the estimation processing changes between the small steering angle region and the large steering angle region to estimate the steering gear ratio n, thereby estimating the steering gear ratio n with satisfactory precision.

According to the steering gear ratio estimating device 1 of this embodiment, the influence of the stability factor K_{H} can be excluded using the equation of motion during traveling in which the traveling condition of a low speed and a low lateral acceleration is satisfied, making it possible to estimate the steering gear ratio n even when the value of the stability factor K_{H} is not known.

In the vehicle of this embodiment, the ECU 4 estimates the steering gear ratio n using the wheel steering angle St and the yaw rate Yr, and changes vehicle control presuming a change in the steering gear ratio n. For this reason, even when the steering gear ratio n differs between vehicles, it is possible to perform vehicle control with satisfactory precision without using the stability factor K_{H}.

The above-described embodiment is an example of the specification information estimating device and the vehicle according to the invention. The specification information estimating device and the vehicle according to the invention are not limited to the steering gear ratio estimating device 1 and the vehicle of the embodiment, and the steering gear ratio estimating device 1 and the vehicle of the embodiment may be modified without departing from the gist of the invention or may be applied to others.

For example, although in the above-described embodiment, the specification information estimating device and the vehicle which estimate the steering gear ratio n have been described, the specification information estimating device and the vehicle according to the invention may estimate the wheelbase L. In estimating the wheelbase L, the wheel speed sensors 12FL to 12RR, the steering torque sensor 25, the steering angle sensor 26, the yaw rate sensor 51, and the lateral G sensor 52 function as a traveling data acquisition unit, and the ECU 4 functions as a vehicle control unit and a wheelbase estimation unit. For example, the wheelbase L can be estimated only by changing a part of the learning (S14) shown in FIG. 3. Hereinafter, processing for estimating the wheelbase L will be simply described. It is assumed that the steering gear ratio n is known.

The ECU 4 calculates the wheelbase L using traveling data input in S10 for the learning permission time determined in S12. Here, the ECU 4 changes an estimation operation depending on whether the wheel steering angle St becomes the small steering angle region (for example, a range of 90 to 180 deg) and the large steering angle region (for example, a range equal to or greater than 180 deg). The ECU 4 calculates the wheelbase L using Expression 5, for example, when the wheel steering angle St becomes the small steering angle region.

$$\begin{matrix}[ Equation 5 ] & \\ L = \frac{V \cdot St}{n \cdot Yr} & ( 5 )\end{matrix}$$

The ECU 4 sets a value obtained by temporally averaging the wheelbase L calculated using Expression 5 as a learning value. Alternatively, when the set wheelbase L is known, the ECU 4 may use a value closest to the set wheelbase L from among the calculated wheelbases L as a learning value.

When the wheel steering angle St becomes the large steering angle region, for example, the ECU 4 sets a correction term for correcting the tire turning angle θ calculated from FIG. 4 as F(St). The wheel steering angle dependency of the tire turning angle θ shown in FIG. 4 can be obtained from the steering gear ratio n and stationary steering data. The ECU 4 calculates the wheelbase L using Expression 6.

$$\begin{matrix}[ Equation 6 ] & \\ L = \frac{V}{Yr} ( \frac{St}{n} - F ( St ) ) & ( 6 )\end{matrix}$$

Similarly to when the wheel steering angle St becomes the small steering angle region, the ECU 4 sets a value obtained by temporally averaging the wheelbase L calculated using Expression 6 as a learning value. Alternatively, when the set wheelbase L is known, the ECU 4 may use a value closest to the set wheelbase L from among the calculated wheelbases L as a learning value.

With the above, the processing for estimating the wheelbase L ends. In this way, the wheelbase L is estimated without using the stability factor K_{H}.

### REFERENCE SIGNS LIST

1: steering gear ratio estimating device (specification information estimating device), 4: ECU (steering gear ratio estimation unit, vehicle control unit), 12FL to 12RR: wheel speed sensor, 22: steering gear box, 25: steering torque sensor, 26: steering angle sensor, 51: yaw rate sensor, 52: lateral G sensor.

1. A specification information estimating device which estimates the steering gear ratio of a vehicle, the device comprising:
a traveling data acquisition unit which acquires the steering angle and the yaw rate of the vehicle during traveling; and
a steering gear ratio estimation unit which estimates the steering gear ratio on the basis of the steering angle and the yaw rate acquired by the traveling data acquisition unit.

2. The device according to claim 1,
wherein the steering gear ratio estimation unit changes processing for estimating the steering gear ratio on the basis of a magnitude relationship between the steering angle and a predetermined threshold value.

3. The device according to claim 1,
wherein the traveling data acquisition unit further acquires the lateral acceleration of the vehicle during traveling, and
the steering gear ratio estimation unit estimates the steering gear ratio using the steering angle and the yaw rate acquired by the traveling data acquisition unit during traveling under the traveling condition that the lateral acceleration is within a predetermined range.

4. The device according to claim 3,
wherein the traveling data acquisition unit further acquires the vehicle speed of the vehicle during traveling, and
the traveling condition includes the condition that an operational value obtained by subtracting a value obtained by accumulating the yaw rate and the vehicle speed when the vehicle speed is within a predetermined range from the lateral acceleration is within a predetermined range, and the steering gear ratio estimation unit estimates the steering gear ratio using the steering angle and the yaw rate acquired by the traveling data acquisition unit during traveling in which the traveling condition is satisfied.

5. A vehicle which performs vehicle control on the basis of a steering gear ratio, the vehicle comprising:
a vehicle control unit which estimates the steering gear ratio on the basis of a steering angle and a yaw rate, and changes vehicle control presuming a change in the steering gear ratio.

6. A specification information estimating device which estimates the wheelbase of a vehicle, the device comprising:
a traveling data acquisition unit which acquires the steering angle and the yaw rate of the vehicle during traveling; and
a wheel base estimation unit which estimates the wheelbase on the basis of the steering angle and the yaw rate acquired by the traveling data acquisition unit.

7. A vehicle which performs vehicle control on the basis of a wheelbase, the vehicle comprising:
a vehicle control unit which estimates the wheelbase on the basis of a steering angle and a yaw rate, and changes vehicle control presuming a change in the wheelbase.
